(19) United States
(12) Patent Application Publication
(10) Pub. No.: US 2026/0197906 A1
(43) Pub. Date: Jul. 9, 2026

(54) COUPLING BOX HAIRPIN REPLACEMENT FOR HIGH VOLTAGE HEATING FIELD

(71) Applicant: WATLOW ELECTRIC MANUFACTURING COMPANY, ST. LOUIS, MO (US)

(72) Inventors: Roger BRUMMELL, Hannibal, MO (US); Scott H. BOEHMER, Hannibal, MO (US); Richard E. YARRINGTON, Hannibal, MO (US); Champ CALDWELL, Perry, MO (US); Michael A. JONES, St. Louis, MO (US)

(73) Assignee: WATLOW ELECTRIC MANUFACTURING COMPANY, ST. LOUIS, MO (US)

(21) Appl. No.: 19/544,404

(22) Filed: Feb. 19, 2026

Related U.S. Application Data
(63) Continuation of application No. PCT/US2024/043893, filed on Aug. 26, 2024.
(60) Provisional application No. 63/578,382, filed on Aug. 24, 2023.

(51) Int. Cl. H05B 3/48; H05B 3/04; H05B 3/06

(52) U.S. Cl. CPC H05B 3/48; H05B 3/04; H05B 3/06; H05B 2203/007; H05B 2203/008; H05B 2203/017

(57) ABSTRACT

A heater assembly includes a pair of heating sections, each heating section including a conductive portion, and a coupling assembly. The coupling assembly includes a coupling enclosure having a housing and an end cap, the end cap secured to a distal end portion of the housing and defining an aperture extending therethrough. A coupling member is disposed inside the housing, and the conductive portions of the pair of heating sections are connected by the coupling member. A closure assembly is disposed within the housing and located between the coupling member and the end cap, the closure assembly defining at least one channel that is in fluid communication with the aperture of the end cap and configured to guide a fluid flowing therein toward an area where the end cap is secured to the housing.

### CROSS-REFERENCE TO RELATED APPLICATIONS

This application is a continuation of International Application No. PCT/US2024/043893, filed on August 26, 2024, claims priority to and the benefit of U.S. provisional application number 63/578,382, filed on August 24, 2023. The disclosures of the above applications are incorporated herein by their reference.

### FIELD

The present disclosure relates to heater assemblies, and more particularly to heater assemblies having resistive heating elements that define one or more turns or bends along their length.

### BACKGROUND

The statements in this section merely provide background information related to the present disclosure and may not constitute prior art.

Conventional resistive heating elements may be arranged to have a serpentine configuration including a plurality of “hairpin” or 180° bends along their lengths in order to provide a higher density of heating elements in an application such as heat exchangers. However, when the resistive heating elements are operating at higher voltages, the dielectric material surrounding the resistive wire or element at the bends can be compromised during manufacturing, reducing the dielectric strength. Furthermore, “hairpin” or 180° bends on a single heating section can limit the overall length of the serpentine configuration due to a single heating element needing to extend a distance to and from a distal end of the heating section.

These issues with resistive heating elements having hairpin bends, or other non-linear paths, are addressed by the present disclosure.

### SUMMARY

This section provides a general summary of the disclosure and is not a comprehensive disclosure of its full scope or all of its features.

In one form, the present disclosure provides a heater assembly that includes a pair of heating sections and a coupling assembly. Each heating section includes a conductive portion. The coupling assembly includes a coupling enclosure, a coupling member, and a closure assembly. The coupling enclosure comprises a housing and an end cap. The end cap is secured to a distal end portion of the housing and defines an aperture extending therethrough. The coupling member is disposed inside the housing of the coupling enclosure. The conductive portions of the pair of heating sections are connected by the coupling member inside the housing of the coupling enclosure. The closure assembly is disposed within the housing and is located between the coupling member and the end cap. The closure assembly defines at least one channel that is in fluid communication with the aperture of the end cap and configured to guide a fluid flowing therein toward an area where the end cap is secured to the housing.

In variations of the heater assembly of the above paragraph, which can be implemented individually or in any combination: the closure assembly comprises an intermediate cap and a backer block disposed within the intermediate cap, the backer block engages the end cap; at least one channel is formed in a surface of the backer block that faces the end cap; at least one channel extends from a center portion of the backer block to a periphery of the backer block; the intermediate cap includes a body portion and a flange portion extending outwardly from the body portion, the flange portion engages an inner surface of the housing; a gauge thickness of the end cap is greater than a gauge thickness of the intermediate cap; the closure assembly is made of a first material and the housing and the end cap are made of a second material that is different from the first material; a fitting is coupled to the end cap and extends at least partially through the aperture in the end cap; the coupling assembly further includes a dielectric material disposed inside the housing for electrically insulating the coupling member and the conductive portions of the heating sections, the dielectric material is disposed between the closure assembly and an element cap disposed at a proximal end of the housing; the element cap includes two apertures, each of the pair of heating sections extending through a respective one of the two apertures; the element cap is welded to the pair of heating sections to form a sealed interface; the pair of heating sections each include a resistive heating element, a sheath surrounding the resistive heating element, and a first dielectric material disposed inside the sheath, wherein the conductive portion extends from the resistive heating element and is exposed from the sheath and the first dielectric material; the conductive portions are welded to the coupling member; the end cap includes an inner circumferential surface that defines the aperture, a leading edge of the inner circumferential surface is chamfered; the opening of the end cap is plugged with a material after the end cap is secured to the distal end of the housing; and the end cap is welded to the housing and the fluid is an inert gas.

In another form, the present disclosure provides a method of forming a heater assembly. The method includes securing a coupling member to conductive portions of a pair of heating sections, placing a housing around the coupling member and conductive portions of the pair of heating sections, filling an internal volume of the housing with dielectric material; compacting the dielectric material, cleaning a closure area, placing an end cap over the closure area, directing an inert gas into the closure area, and welding the end cap to the housing while the inert gas is being directed into the closure area.

In variations of the method of the above paragraph, which can be implemented individually or in any combination: the inert gas is directed through an aperture formed through the end cap, and the aperture is closed after the end cap is welded to the housing; and the aperture is closed by a subsequent welding step.

In yet another form, the present disclosure provides a heater assembly that includes a pair of heating sections and a coupling assembly. Each heating section includes a conductive portion. The coupling assembly includes a coupling enclosure and a closure assembly. The coupling enclosure comprises a housing and an end cap. The end cap is secured to a distal end portion of the housing and defines an aperture extending therethrough. The conductive portions of the pair of heating sections are connected to each other inside the housing of the coupling enclosure. The closure assembly is disposed within the housing and is located between the conductive portions and the end cap. The closure assembly defines at least one channel that is in fluid communication with the aperture of the end cap and configured to guide a fluid flowing therein toward an area where the end cap is secured to the housing.

In variations of the heater assembly of the above paragraph, which can be implemented individually or in any combination: the conductive portions of the pair of heating sections are connected to each other by welding or crimping and the conductive portions of the pair of heating sections are connected directly to each other.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a heat exchanger in which a heater assembly constructed in accordance with the teachings of the present disclosure is disposed;

FIG. 1B is a perspective, partial cross-sectional view of an end portion of the heat exchanger of FIG. 1A;

FIG. 2 is a cross-sectional view of a heating section of a heater assembly of FIG. 1B;

FIG. 3 is a perspective view of a portion of the heater assembly including a coupling assembly constructed in accordance with the teachings of the present disclosure, with a housing of the coupling assembly shown transparent for clarity;

FIG. 4 is a side view of the coupling assembly of FIG. 3 with the housing of the coupling assembly shown transparent for clarity and with a fitting coupled to an end cap of the coupling assembly;

FIG. 5 is a cross-sectional view of the coupling assembly of FIG. 3;

FIG. 6 is a perspective view of a backer block of the coupling assembly of FIG. 3;

FIG. 7 is a perspective view of an element cap of the coupling assembly of FIG. 3;

FIG. 8A is a perspective view of a coupling enclosure of the coupling assembly of FIG. 3 with the fitting removed and the end cap welded to a housing of the coupling enclosure;

FIG. 8B is a perspective view of the coupling enclosure of the coupling assembly of FIG. 3 with an opening of the end cap plugged and sealed; and

FIG. 9 is a flowchart illustrating a method for forming a heating assembly according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

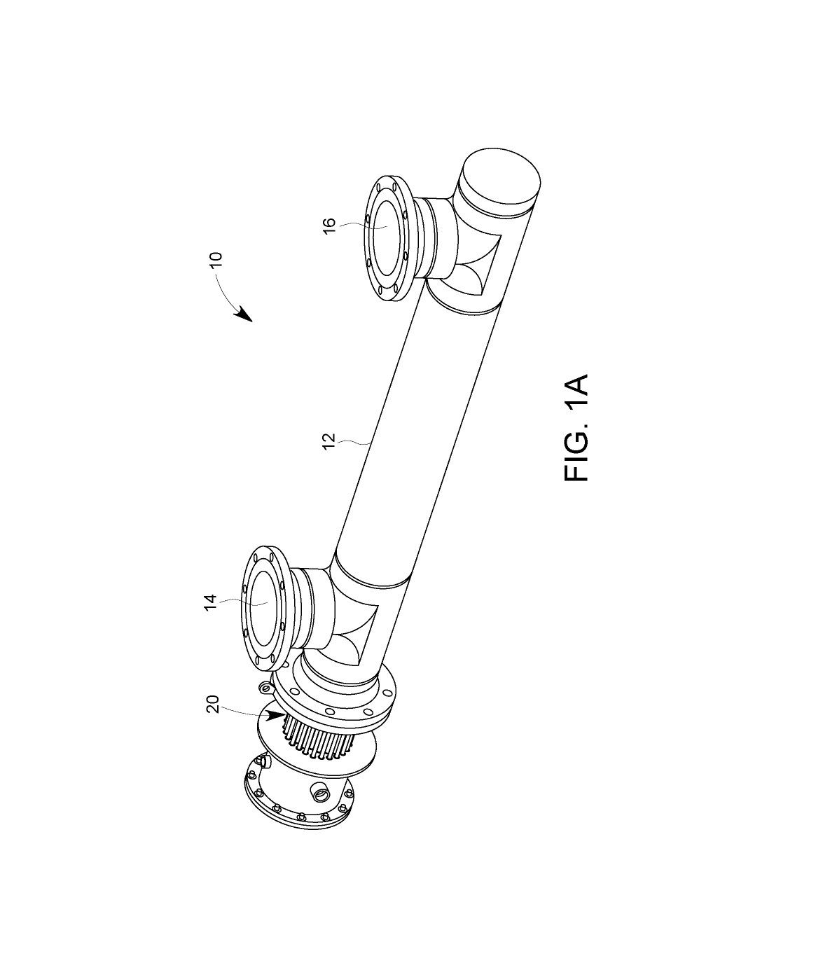

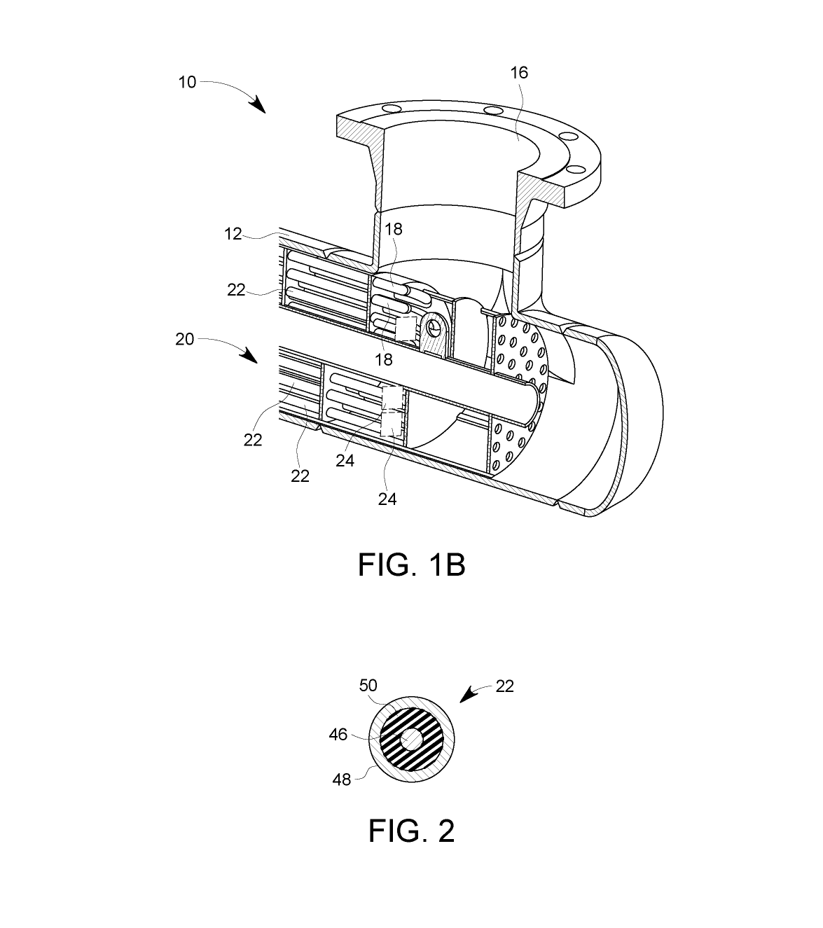

Referring to FIGS. 1A and 1B, a heater assembly 20 constructed in accordance with the teachings of the present disclosure is illustrated. The heater assembly 20 in one form is used for high voltage (e.g., greater than about 480 Volts) applications. One such application is described in U.S. Patent No. 10,941,988, which is commonly owned with the present application and the contents of which are incorporated by reference in its entirety. In this application, the heater assembly 20 is used in a heat exchanger 10, which generally includes a tubular vessel 12 defining an inlet 14 and an outlet 16, and one or more heater assemblies 20 disposed inside the tubular vessel 12 for heating a fluid flowing into the inlet 14 and exiting the outlet 16.

As clearly shown in FIG. 1B, in one form, the heat exchanger 10 includes one or more heater assemblies 20 including a plurality of heating sections 22 and a plurality of coupling assemblies 24 (schematically shown in dashed rectangular boxes) for connecting the plurality of heating sections 22. To better illustrate the interchangeability of a bend 18 of a typical heater and a coupling assembly 24 of the present disclosure, some of the heating sections 22 are connected by the coupling assemblies 24, whereas some of the heating sections 22 may be connected by the bends 18 of a typical heater without being replaced by the coupling assemblies 24. Alternately, the coupling assemblies 24 may be employed at each end portion where the heating section 22 turns back the other direction. In one form, the heater assembly 20 includes a pair of heating sections 22 connected by a coupling assembly 24. In another form, the heater assembly 20 may include multiple pairs of heating sections 22 connected by a plurality of coupling assemblies 24.

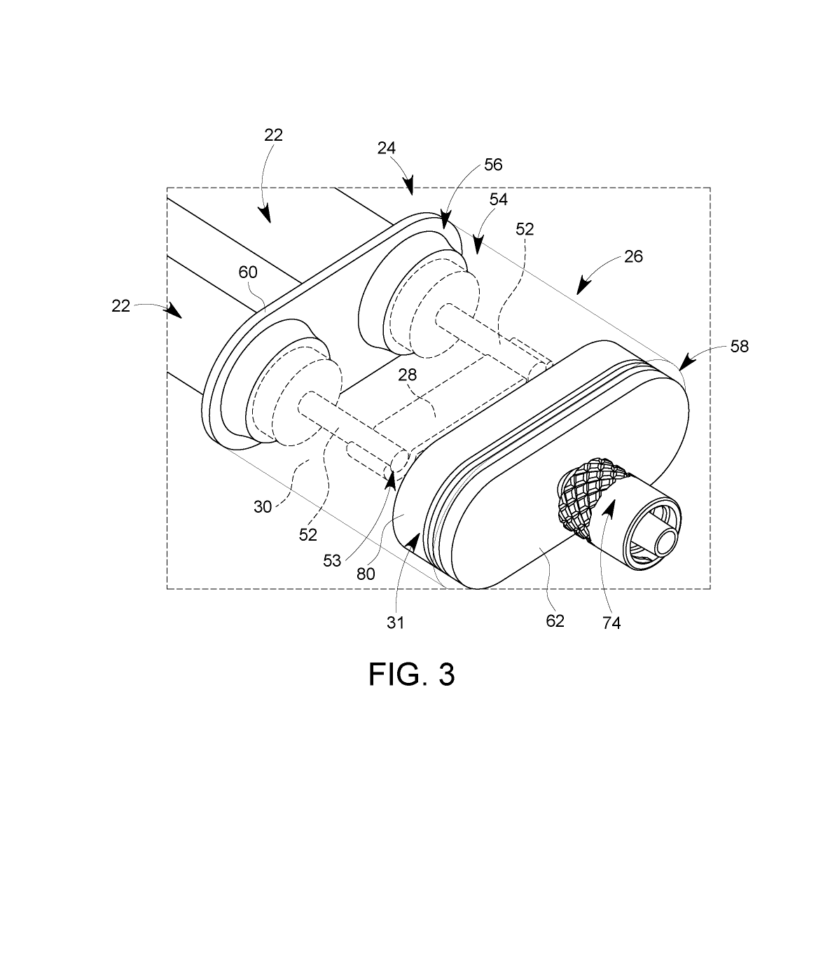

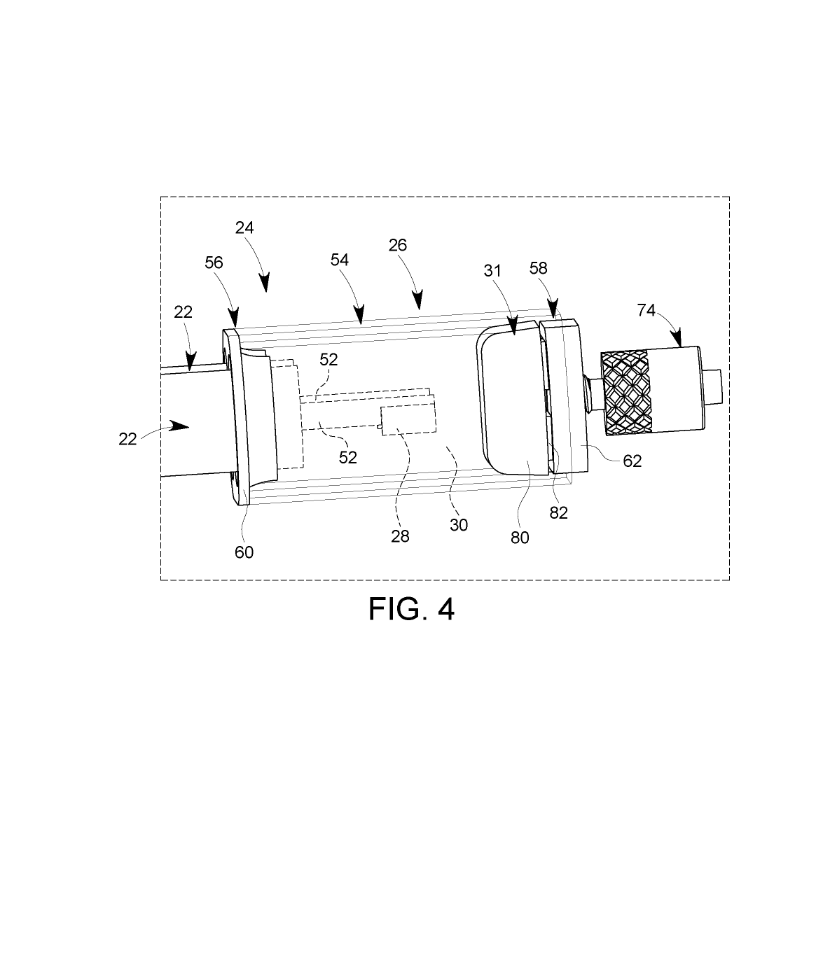

Referring to FIGS. 2-5, in one form, the heater assembly 20 includes a pair of heating sections 22 and a coupling assembly 24 for connecting the pair of heating sections 22. The coupling assembly 24 includes a coupling enclosure 26, a coupling member 28 disposed inside the coupling enclosure 26, a dielectric material 30 disposed inside the coupling enclosure 26 for embedding and electrically insulating the coupling member 28 and portions of the heating sections 22 connected to the coupling member 28, and a closure assembly 31 disposed within the coupling enclosure 26. The coupling enclosure 26 is illustrated in FIGS. 3 and 4 with transparent surfaces for purposes of clarity to view the components internal to the coupling enclosure 26. In one form, the coupling enclosure 26 may have an oval shaped cross-section as shown and define a pair of apertures (FIG. 7) 32 to allow end portions of the pair of the heating sections 22 to be inserted therein. In another form, the coupling enclosure 26 may have a box-shaped geometry, among other geometries, without departing from the scope of the present disclosure.

The pair of heating sections 22 each have opposing ends. One of the opposing ends of each of the heating section 22 is inserted into a corresponding one of the apertures 32 to be connected to the coupling member 28 disposed inside the coupling enclosure 26, and the other one of opposing ends is connected to a power source or a controller (not shown) to complete an electric circuit. The coupling member 28 is thus made of an electrically conductive material. When more than two heating sections 22 are used, two or more coupling assemblies 24 may be used to connect these heating sections 22 and thus one or more of the heating sections 22 may have both opposing ends connected to an adjacent one of the coupling assemblies 24. The heating sections 22 in one form are arranged to be parallel to one another, or alternatively, the heating sections 22 may be arranged at an angle relative to one another depending on application requirements/limitations. In either case, the coupling assembly 24 is used to electrically and mechanically couple adjacent ends of two heating sections 22, which would otherwise be joined by a 180° “bend” 18 (shown in FIG. 1B) or “hairpin” structure in a typical heater assembly. Therefore, the heating sections 22 and the coupling assemblies 24 are arranged and connected to define a heating assembly with one or more turns or a heating assembly having, for example, a serpentine configuration.

Referring to FIG. 2, the pair of heating sections 22 each include a resistive heating element 46, a sheath 48 surrounding the resistive heating element 46, and a dielectric material 50 disposed inside the sheath 48 to embed and electrically insulate the resistive heating element 46. The resistive heating elements 46 may be in the form of a resistive coil (not shown). The dielectric material 50 in one form is magnesium oxide (MgO) and is compacted around the resistive heating element 46 within the sheath 48. Such a construction of heating elements, including the conventional hairpin bend as set forth above, is described in U.S. Patent No. 9,113,501, which is commonly owned with the present application and the contents of which are incorporated herein by reference in its entirety.

The dielectric material 50 may be the same as or different from the dielectric material 30 inside the coupling enclosure 26 of the coupling assembly 24. In one form, both the dielectric materials 30 and 50 are MgO. However, it should be understood that a variety of insulating materials other than, or in combination with, MgO may be employed while remaining within the scope of the present disclosure.

Referring to FIGS. 3-5, each of the heating sections 22 further include a conductive portion in the form of a conductive pin 52 connected to and extending from an end of the resistive heating element 46. As shown, a portion of the dielectric materials 50 surrounds the conductive pins 52 and is exposed from the sheath 48. The conductive pin 52 has an end portion exposed from the dielectric material 50 and the sheath 48 for contacting the coupling member 28. The coupling member 28 extends between and is in electrical contact with the conductive pins 52 and in this form includes recesses 53 that are circular to conform to the conductive pins and thus provide more contact area. In one form, the coupling member 28 is a copper material. In another form, the coupling member 28 is a nickel plated steel. The coupling member 28 thus provides an electrical connection between the conductive pins 52 and consequently between the resistive heating elements 46 of the heating sections 22. As the resistive heating elements 46 are a nickel alloy in one form, the coupling member 28 is a different material than the resistive heating elements 46. However, the materials may be the same. As one example, the resistive heating elements 46 may have a cold pin (not shown) that is a nickel plated steel, and the coupling member 28 may also be a nickel plated steel.

In one form, the coupling member 28 is welded to the conductive pins 52 to provide a more robust connection for operating at higher voltages. As an example, the coupling member 28 may be in the form of a plate having the recesses 53 that correspond to the shape of the conductive pins 52 for supporting the conductive pins 52 therein. In this way, the coupling member 28 at least partially wraps around the conductive pins 52. In another example, the coupling member 28 may be in the form of a flat plate (without the recesses 53) for supporting the conductive pins 52 thereon. While not shown in the drawings, it is understood that the conductive pins 52 may be secured to the coupling member 28 by any attachment means (welding, brazing, thermal adhesive, mechanical fastener, among others) without departing from the scope of the present disclosure.

Therefore, the coupling member 28 is used to replace a traditional hairpin, or 180° bend, coupling the resistive heating elements such as those in a circulation heater as set forth above. Replacing the typical hairpin or 180° bend with the coupling member 28 generally increases the overall dielectric strength of the heater assembly 20 and reduces "current crowding" in the bend portion. Typically, the hairpin or 180° bend portion of a typical heater is an integral part of the resistive heating element 46. By using a coupling member 28 as a separate component from the resistive heating elements 46 and having lower electrical resistance and by increasing the amount of dielectric material 30 around the adjacent ends of the heating sections 22, the dielectric strength in the coupling assembly is improved.

With reference to FIGS. 3-5, the coupling enclosure 26 includes a housing 54 having a proximal end portion 56 and a distal end portion 58, an element cap 60 disposed at the proximal end portion 56, and an end cap 62 disposed at the distal end portion 58. While the coupling enclosure 26 is shown to have an oval shape cross-section, the coupling enclosure may have any other configurations (e.g., “box” shape) as long as the coupling enclosure 26 can enclose the exposed portions of the conductive pins 52, the coupling member 28, the dielectric material 30, and the closure assembly 31 therein. The housing 54 is generally hollow and defines opposed openings at the proximal end portion 56 and the distal end portion 58. The element cap 60 and the end cap 62 are connected to the opposed ends of the housing 54 to close and seal the interior space of the housing 54. The connections of the element cap 60 and the end cap 62 to the housing 54 are described in greater detail below.

As shown in FIG. 7, the element cap 60 includes a plate portion 64 defining the pair of apertures 32 and a pair of flanges 66 disposed along peripheries of the apertures 32. The flanges 66 may be extruded or machined to provide cylindrical surfaces to surround the sheaths 48 of the heating section 22 when the heating sections 22 are inserted into the apertures 32. As shown, the flanges 66 extend inwardly towards the respective heating sections 22 to provide a more secure interface therebetween. In one form, the heating sections 22 are welded to the element cap 60 by welding the sheaths 48 of the heating section 22 to the internal surfaces of the flanges 66. The element cap 60 may be a separate component from the housing 54, or the element cap 60 and the housing 54 may be integrally formed (e.g., machined, 3D printed, among others). In one form, after the heating sections 22 are welded to the element cap 60, the element cap 60 is be welded to the housing 54. It should be understood that welding is merely one example of a joining technique and thus other techniques/materials (such as by way of example adhesive bonding) may be employed while remaining within the scope of the present disclosure.

The apertures 32 and the flanges 66 allow ends of the heating sections 22 to be inserted therein such that the sheaths 48 of the heating sections 22 contact the internal surfaces of the flanges 66 of the element cap 60. In one form, the sheaths 48 of the heating sections 22 are welded to the flanges 66 of the element cap 60 to form a sealed interface/structure between the heating sections 22 and the element cap 60. In another form, a sealing member (not shown), such as an O-ring, may be disposed between each of the sheaths 48 of the heating sections 22 and a corresponding one of the flanges 66 of the element cap 60. This sealed interface/structure can also provide a pressure boundary for applications such as a fluid circulation heater. The element cap 60 is also welded to the proximate end portion 56 of the housing 54 to form a sealed interface therebetween.

Referring to FIGS. 3-5, the end cap 62 in one form has a plate configuration and is attached to the distal end portion 58 of the housing 54, opposite the element cap 60, as shown. The end cap 62 is at least partially disposed within the distal end portion 58 of the housing 54 and functions as a closure to seal the internal volume of the housing 54. Although the end cap 62 is shown partially recessed within the housing 54, the end cap 62 may take on a number of geometries to close the internal volume of the housing 54 while remaining within the scope of the present disclosure. In one form, the end cap 62 is made of a material that is the same as the material of the housing 54. In this way, the coefficient of thermal expansion (CTE) of the end cap 62 and the housing 54 are the same, which is advantageous during welding the end cap 62 and the housing 54 to each other, as described in greater detail below. In one example, the end cap 62 and the housing 54are made of a nickel alloy.

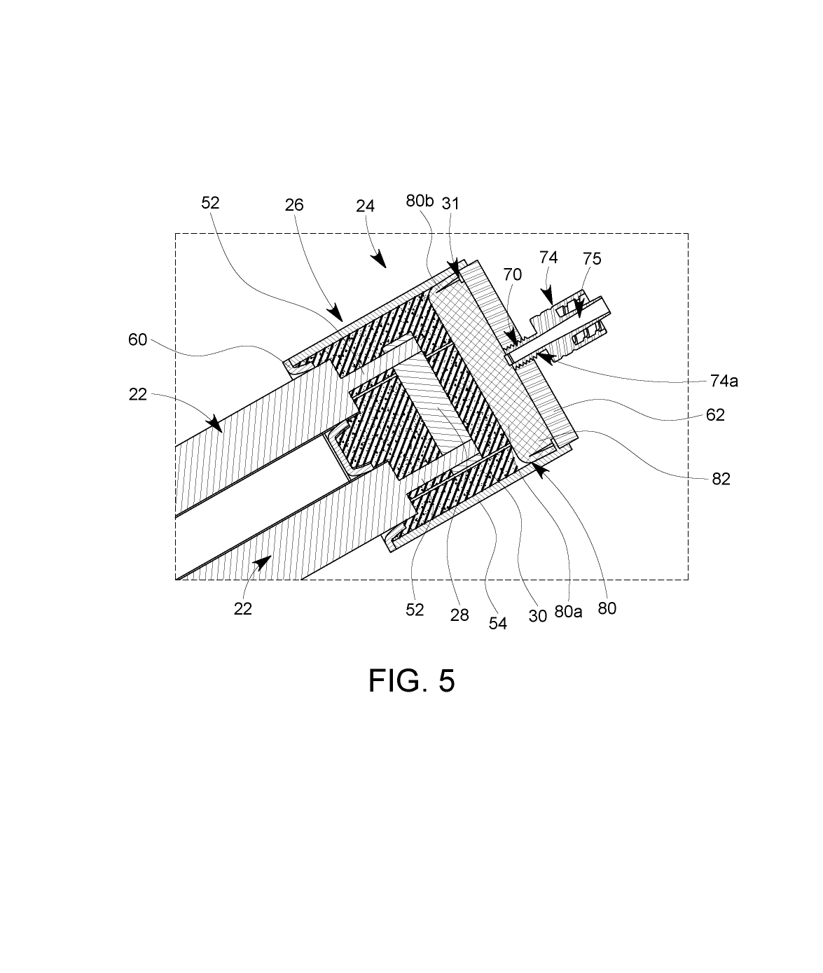

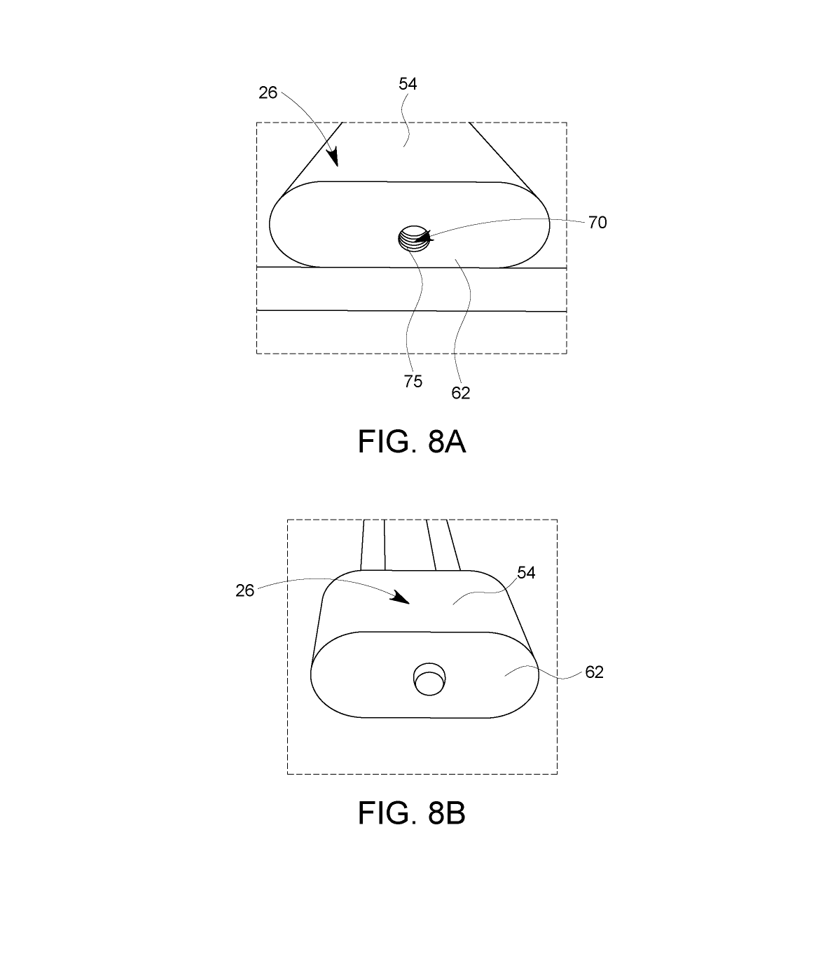

In the example illustrated, the end cap 62 includes an aperture or opening 70 (FIG. 5) that extends through the end cap 62 in a direction that is parallel to a longitudinal direction of the heating sections 22. In other forms, however, the aperture 70 may extend through the end cap 62 in a direction that is at an angle to the longitudinal direction of the heating sections 22, as long as the aperture 70 is in fluid communication with other features defined by the closure assembly 31 as set forth in greater detail below. In the example illustrated, the aperture 70 is threaded such that the end cap 62 can coupled to a fitting 74. In other forms, the aperture 70 is unthreaded and the fitting 74 is coupled to the end cap 62 using any suitable attachment means such as a tapered interface, an adapter, or a quick disconnect mechanism, by way of example. In one form, a leading edge 75 (FIG. 8A) of the aperture 70 is chamfered so as to facilitate insertion of the fitting 74 into the aperture 70 more easily.

The fitting 74 defines an internal passageway 75 as shown and is coupled to the end cap 62 such that an end portion 74a of the fitting 74 is at least partially received in the aperture 70 of the end cap 62. In this way, the fitting 74 is in fluid communication with the coupling enclosure 26, and more specifically with the closure assembly 31. In order to weld the end cap 62 to the housing 54, a tube (not shown) extends at least partially through the internal passageway 75 of the fitting 74 and permits a fluid (e.g., an inert gas such as argon) to flow therethrough and into the closure assembly 31, as will be described in greater detail below. In the example illustrated, the end portion 74a of the fitting 74 is externally threaded along an outer circumferential surface. In this way, the fitting 74 is threadably engaged with the internal threads of the end cap 62.

It should be understood that that the end cap 62 may take on a number of geometrical configurations other than those illustrated herein, provided the end cap is configured to close the distal end portion 58 of the housing 54 and to provide a sealed interface. Accordingly, the specific configuration of the end cap 62 should not be construed as limiting the scope of the present disclosure.

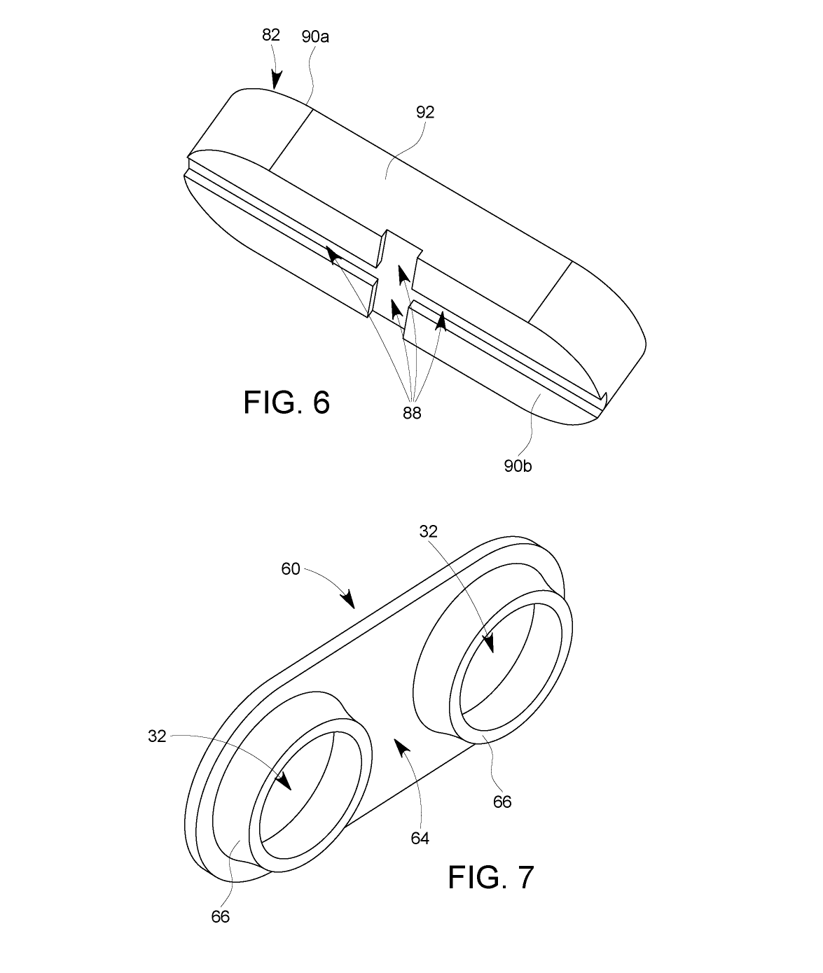

With reference to FIGS. 3-5 and 8, the closure assembly 31 is disposed within the housing 54 and generally includes the end cap 62, an intermediate cap 80, and a backer block 82, each of which are configured to provide a sealing enclosure that reduces the tendency of the dielectric material to "sugar" or oxidize during the welding process to finally seal the coupling enclosure 26. As shown, the backer block 82 defines one or more channels 88 (FIG. 6) that are in fluid communication with the aperture 70 of the end cap 62 and the internal passageway 75 of the fitting 74. In this way, the inert gas flowing through the fitting 74 and the end cap 62 during a welding process flows into the channels 88 and into an area or interface of the coupling enclosure 26 where the end cap 62 and the housing 54 are welded together. Accordingly, the occurrence of oxidation of the weld filler material during welding is reduced. The closure assembly 31 of the present disclosure separates the compacted dielectric material 30 from the area where the end cap 62 and the housing 54 are welded, thereby reducing contamination of the weld joint.

The closure assembly 31 is also disposed within the coupling enclosure 26 to create a compacted dielectric material 30, and more specifically with the intermediate cap 80 and the backer block 82. After the dielectric material 30 is compacted by the intermediate cap 80 and the backer block 82, the area is cleaned before placing the end cap 62 in position. Once the end cap 62 is in position, the end cap 62 may then be welded to the housing 54 to close and seal the housing 54. The closure assembly 31 is located between the dielectric material 30 and the end cap 62 and inhibits the dielectric material 30 from moving toward the end cap 62 especially during welding of the end cap 62 to the housing 54.

With reference specifically to FIG. 5, the intermediate cap 80 and backer block 82 are shown in greater detail. In the example illustrated, the intermediate cap 80 and the backer block 82 are made of two pieces. In another form, the intermediate cap 80 and the backer block are made from a single piece to reduce the number of parts of the coupling assembly 24. In the example illustrated, the intermediate cap 80 abuts the dielectric material 30 and generally has a "cup" shape. The intermediate cap 80 may be made of a material that is the same as the material of the backer block 82. In some forms, the material that the intermediate cap 80 and the backer block 82 is made of is the same as the material of the housing 54 and the end cap 62. In another form, the material that the intermediate cap 80 and the backer block 82 is made of is different from the material of the housing 54 and the end cap 62. That is, as an example, the housing 54 and the end cap 62 may be made of a nickel alloy and the intermediate cap 80 and the backer block 82 may be made of stainless steel.

In the example illustrated, the intermediate cap 80 has a gauge thickness that is less than a gauge thickness of the end cap 62 and includes a body portion 80a and a flange portion 80b. The body portion 80a cooperates with the flange portion 80b to form a cavity that the backer block 82 is at least partially disposed in. The body portion 80a extends along a direction that is parallel to the direction that the coupling member 28 extends and perpendicular to the longitudinal direction of the heating sections 22. The flange portion 80b extends outwardly from a periphery of the body portion 80a and engages an inner surface of the housing 54. In this way, the dielectric material 30 is inhibited from moving around the closure assembly 31 toward the end cap 62. In the example illustrated, the flange portion 80b extends outwardly from the periphery of the body portion 80a at angle. The flange portion 80b is also elastically deformed when placed inside the housing 54 and against the dielectric material 30, and thus the angle of the flange portion 80b provides a more robust interface against the internal surface of the housing 54 and also accommodates manufacturing variations, or tolerance build-ups. Further, the flange portion 80b in this configuration maintains engagement with the inner surface of the housing 54 when the coupling enclosure 26 goes through thermal expansion, for example.

With reference to FIGS. 5 and 6, the backer block 82 is at least partially disposed within the intermediate cap 80 and is located between the intermediate cap 80 and the end cap 62. In the example illustrated, the backer block 82 has a gauge thickness that is greater than the gauge thickness of the end cap 62 and includes a pair of opposed end surfaces 90a, 90b (FIG. 6). The backer block 82 also extends at least partially beyond the intermediate cap 80 such that the end surface 90b engages the end cap 62 (FIG. 5). As shown clearly in FIG. 6, the channels 88 are formed in the end surface 90b of the backer block 82 and are configured to be in fluid communication with the aperture 70 of the end cap 62, and also the internal passageway 75 of the fitting 74. In one example, the channels 88 are machined in the end surface 90b of the backer block 82. In the example illustrated, the channels 88 cooperate to form an X-shape or “+”shape where the channels 88 extend from a center portion of the end surface 90b to an outer surface 92 at a periphery of the backer block 82. In this way, fluid flowing through the fitting 74 and the aperture 70 of the end cap 62 is guided or directed by the channels 88 to the periphery of the backer block 82 near or at an area where the end cap 62 is welded to the housing 54.

It should be understood that the channels 88 may form a variety of shapes and orientations in the backer block 82, provided fluid is permitted to be directed or guided toward predetermined locations at the periphery of the backer block 82. In one form, the backer block 82 may be spaced apart from the end cap 62 thereby defining one or more channels. In this way, fluid flowing through the fitting 74 and the end cap 62 is directed to a periphery of the backer block 82 for the welding process. In another form, channels may be formed in the outer surface 92 of the backer block 82 and may be in fluid communication with an aperture 70 extending through the end cap 62. In this way, fluid flowing through the end cap 62 is directed to the periphery of the backer block 82 with little to no redirection in the coupling enclosure 26. After the end cap 62 is welded to the housing 54, the fitting 74 is removed from the end cap 62 (FIG. 8A) and the aperture 70 of the end cap 62 is plugged or closed off. In one example, the aperture 70 is welded closed as shown in FIG. 8B. In another example, the aperture 70 may be closed using a separate plug (not shown) or other body such that the coupling enclosure 26 is sealed after the welding process.

In the configuration described above, the coupling enclosure 26 encloses the coupling members 28 and the conductive pins 52 of the heating sections 22. The dielectric material 30 is disposed within the coupling enclosure 26 and surrounds the conductive pins 52 and the coupling member 28. The dielectric material 30 isolates the conductive pins 52 of the heating sections 22 and the coupling member 28 from the coupling enclosure 26 and its other components. Although only two heating sections 22 and one coupling assembly 24 are illustrated and described, it should be understood that a plurality of heating sections 22 and a plurality of coupling assemblies 24 may be employed to define a serpentine configuration while remaining within the scope of the present disclosure.

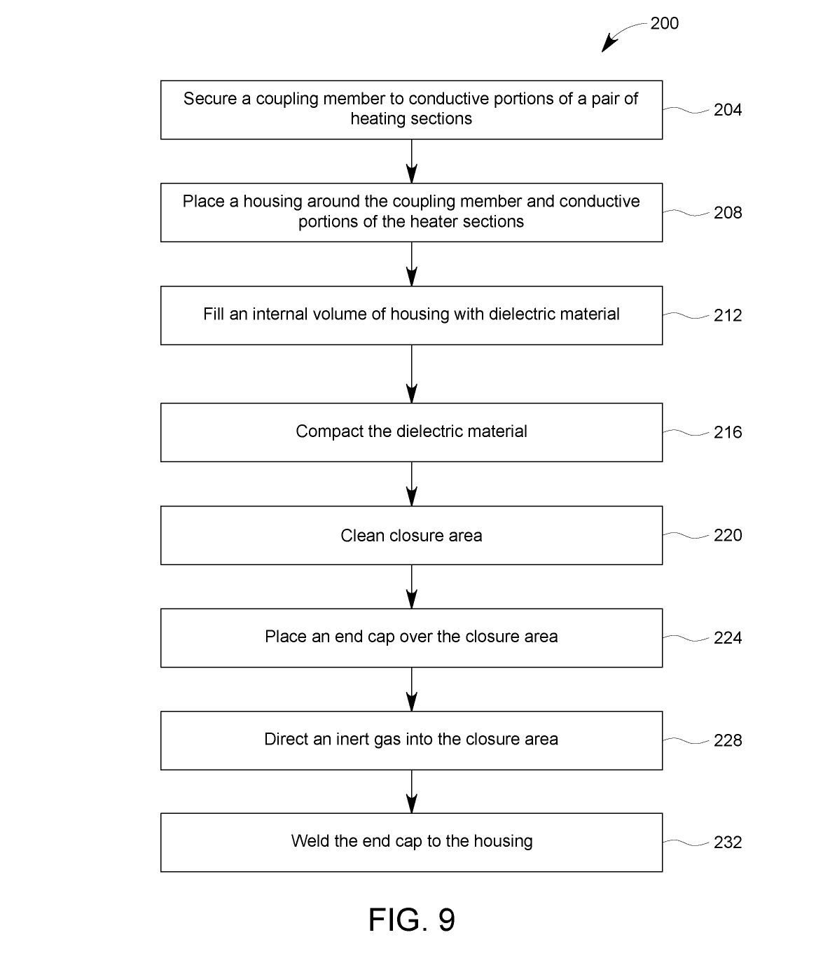

With reference to FIG. 9, a method 200 for forming a heater assembly 20 is illustrated. First, at 204, the coupling member 28 is secured to conductive portions 52 of the pair of heating sections 22. Then, at 208, the housing 54 is placed around the coupling member 28 and the conductive portions 52 of the pair of heating sections 22. Then, at 212, an internal volume of the housing 54 is filled with the dielectric material 30. Then, at 216, the dielectric material 30 is compacted. In this way, the dielectric material 30 is spaced apart from the closure area. In one form, the dielectric material 30 is compacted within the housing 54 using the closure assembly 31. In another form, the dielectric material 30 is compacted within the housing 54 using a separate tool (not shown).

Then, at 220, a closure area of the housing 54 is cleaned. In one example, the closure area is cleaned using pressurized fluid, for example, or any other suitable cleaning fluid. Then, at 224, the end cap 62 is placed over the closure area. In the example illustrated, the end cap 62 is placed over the closure area such that the end cap 62 is at least partially disposed within the housing 54. In other forms, the end cap 62 is placed over the closure area such that the end cap 62 is located entirely outside of the housing 54. Then, at 228, an inert gas is directed into the closure area. In the example illustrated, the inert gas is directed into the closure area through a fitting 74 coupled to the end cap 62 and through the aperture 70 formed in the end cap 62. Then, at 232, the end cap 62 is welded to the housing 54 while the inert gas is directed into the closure area. After the end cap 62 is welded to the housing 54, the aperture 70 formed in the end cap 62 is closed so that inert gas within the closure area is inhibited from escaping. The closing of the aperture 70 may be carried out by a subsequent welding step, for example.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A heater assembly comprising:
a pair of heating sections, each heating section including a conductive portion; and
a coupling assembly including:
a coupling enclosure comprising a housing and an end cap, the end cap secured to a distal end portion of the housing and defining an aperture extending therethrough, the conductive portions of the pair of heating sections being connected to each other inside the housing of the coupling enclosure; and
a closure assembly disposed within the housing and located between the conductive portions and the end cap, the closure assembly defining at least one channel that is in fluid communication with the aperture of the end cap and configured to guide a fluid flowing therein toward an area where the end cap is secured to the housing.

2. The heater assembly according to claim 1, further comprising a coupling member disposed inside the housing of the coupling enclosure, the conductive portions of the pair of heating sections being connected by the coupling member inside the housing of the coupling enclosure.

3. The heater assembly according to claim 2, wherein the closure assembly comprises an intermediate cap and a backer block disposed within the intermediate cap, and wherein the backer block engages the end cap.

4. The heater assembly according to claim 3, wherein the at least one channel is formed in a surface of the backer block that faces the end cap.

5. The heater assembly according to claim 4, wherein the at least one channel extends from a center portion of the backer block to a periphery of the backer block.

6. The heater assembly according to claim 3, wherein the intermediate cap includes a body portion and a flange portion extending outwardly from the body portion, and wherein the flange portion engages an inner surface of the housing.

7. The heater assembly according to claim 3, wherein a gauge thickness of the end cap is greater than a gauge thickness of the intermediate cap.

8. The heater assembly according to claim 2, wherein the closure assembly is made of a first material and the housing and the end cap are made of a second material that is different from the first material.

9. The heater assembly according to claim 2, further comprising a fitting coupled to the end cap and extending at least partially through the aperture in the end cap.

10. The heater assembly according to claim 2, wherein the coupling assembly further includes a dielectric material disposed inside the housing for electrically insulating the coupling member and the conductive portions of the heating sections, and wherein the dielectric material is disposed between the closure assembly and an element cap disposed at a proximal end of the housing.

11. The heater assembly according to claim 10, wherein the element cap includes two apertures, each of the pair of heating sections extending through a respective one of the two apertures.

12. The heater assembly according to claim 10, wherein the element cap is welded to the pair of heating sections to form a sealed interface.

13. The heater assembly according to claim 1, wherein the pair of heating sections each include a resistive heating element, a sheath surrounding the resistive heating element, and a first dielectric material disposed inside the sheath, wherein the conductive portion extends from the resistive heating element and is exposed from the sheath and the first dielectric material.

14. The heater assembly according to claim 2, wherein the conductive portions are welded to the coupling member.

15. The heater assembly according to claim 1, wherein the end cap includes an inner circumferential surface that defines the aperture, and wherein a leading edge of the inner circumferential surface is chamfered.

16. The heater assembly according to claim 1, wherein an opening of the end cap is plugged with a material after the end cap is secured to the distal end of the housing.

17. The heater assembly according to claim 1, wherein the end cap is welded to the housing and the fluid is an inert gas.

18. The heater assembly according to claim 1, wherein the conductive portions of the pair of heating sections are connected to each other by welding or crimping.

19. The heater assembly according to claim 1, wherein the conductive portions of the pair of heating sections are connected directly to each other.

20. A method of forming a heater assembly, the method comprising:
securing a coupling member to conductive portions of a pair of heating sections;
placing a housing around the coupling member and conductive portions of the pair of heating sections;
filling an internal volume of the housing with dielectric material;
compacting the dielectric material;
cleaning a closure area;
placing an end cap over the closure area;
directing an inert gas into the closure area; and
welding the end cap to the housing while the inert gas is being directed into the closure area.

21. The method according to claim 20, wherein the inert gas is directed through an aperture formed through the end cap, and the aperture is closed after the end cap is welded to the housing.

22. The method according to claim 21, wherein the aperture is closed by a subsequent welding step.
